(19) United States
(12) Patent Application Publication
(10) Pub. No.: US 2006/0003223 A1
(43) Pub. Date: Jan. 5, 2006

(54) Nickel hydrogen battery

(76) Inventors: Christopher D Willson, Pittsfield, MA (US); John P Hogan JR., Williamstown, MA (US); Steven S Garrant, Becket, MA (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/492,489

(22) PCT Filed: Oct. 9, 2002
(86) PCT No.: PCT/US02/32408

§ 371 Date: Jan. 18, 2005

Related U.S. Application Data
(60) Provisional application No. 60/327,980, filed on Oct. 9, 2001.

(51) Int. Cl. H01M 2/08; H01M 2/16; H01M 10/50

(52) U.S. Cl. 429/185; 429/246; 429/149; 29/623; 429/120; 429/50

(57) ABSTRACT

A segmented nickel hydrogen battery system includes a hydrogen storage segment (130) and a battery segment (120) in fluid communication with the storage segment. The battery segment includes a plurality of electrochemical cells each having a current collector plate (104) and a plastic seal component (104) provided about the peripheral edge of the collector plate. The plastic seal component may be secured to the collector plate using a variety of methods, but is preferably injection-molded about the collector plate edge. The collector plate/seal segment subassemblies may then be stacked and the seal components bonded together to form an integral seal. The electrodes and separator are placed between the collector plates before bonding. Preferably, the electrodes and separator are formed as a bipolar cell construction.

### BACKGROUND OF THE INVENTION

The present invention generally relates to electrochemical batteries. More specifically, the present invention relates to an improved construction and seal for electrochemical cells and batteries, which is particularly suitable for use in segmented nickel hydrogen batteries.

U.S. Pat. Nos. 4,396,114; 5,047,301; 5,250,368; 5,419,981; 5,532,074; 5,688,611; and 6,042,960 disclose various aspects of segmented nickel hydrogen battery systems. As generally described in U.S. Pat. No. 6,042,960 and shown in FIG. 1, a nickel hydrogen battery system may include a hydrogen storage segment 10 and an electrochemical battery segment 12 such as a nickel hydrogen battery segment, which has a positive electrode 14 and a negative electrode 16. As described further below, electrochemical battery segment 12 includes a plurality of stacked electrochemical cells. The battery segment 12 is in fluid communication with hydrogen storage segment having a hydrogen storage chamber 18, which is defined by housing wall(s) 19. The fluid communication is typically through means of piping 20. Piping 20 thus provides a hydrogen gas transmission path through the system. Included in hydrogen storage chamber 18 is a hydrogen storage material 50, such as metal hydride particles. The hydrogen storage segment may further include a spring mechanism 24 that provides a fluid passage for speedier dispersal of the hydrogen gas throughout the hydrogen storage material 50, as taught by U.S. Pat. No. 4,396,114. Additional check valves and other structures along the path between battery 12 and hydrogen storage segment 10 may be provided as disclosed in the above-referenced patents.

During discharge, hydrogen gas is drawn from the metal hydride storage material in the hydrogen storage segment 10 by the battery segment 12. During recharging, the hydrogen gas flows in the opposite direction from the battery segment 12 to the hydrogen storage segment 10 where the hydrogen reacts with the metal hydride for storage until such time that the battery segment 12 begins to discharge.

As the hydrogen gas flows from the hydrogen storage segment to the battery segment, the hydrogen storage segment cools and the electrochemical segment increases in temperature. The cooling of the hydrogen storage segment slows the release of hydrogen from the metal hydride in which it is stored. Without the addition of heat to the hydrogen storage segment, the battery system will stop functioning. As the power demand on the battery system is increased, more hydrogen gas is needed at a faster rate. The availability and rate of availability of this gas is dependent on proper heat flow back to the hydrogen storage segment. The prior art segmented nickel hydrogen battery systems, however, have not provided adequate and suitable means for ensuring proper heating of the hydrogen storage segment. Accordingly, there exists the need for an improvement to the structure of a segmented nickel hydrogen battery system so as to ensure proper heating of the hydrogen storage segment.

FIG. 2 shows an example of the detailed construction of a prior art nickel hydrogen battery segment 12. In general, it is noted that battery segment 12 includes end plates 60 and 65, which are joined together via long external bolts 80. One or more current collector plates 24 may be secured between end plates 60 and 65 and which include apertures 28 through which bolts 80 may slidably extend. In general, there is a collector plate 24 between each cell within battery segment 12. Each cell includes a hydrogen diffuser screen 22; a negative electrode 16 typically made of a material including platinum; a separator 19, which may be a glass fiber soaked in KOH; and a positive electrode 14, which may be made of Ni(OH)₂. Seals 70 are provided between each of the collector plates 24 and end plates 60 and 65. O-ring gaskets 74 and 78 may be provided in grooves provided within the ends of the seals to ensure proper sealing. An inlet 56 is further provided through one of the end plates for connection to piping 20 for the introduction and exit of hydrogen gas. Additional details are not described herein, but rather are disclosed in U.S. Pat. No. 5,419,981, the entire disclosure of which is incorporated by reference.

As will be apparent to those skilled in the art, the construction of a battery such as that shown in FIG. 2 is rather complex and is not particularly well suited for mass production. Furthermore, the battery seal is critical to the long life of the battery system. The battery seal maintains the required electrolyte to be present in the battery enabling the ionic transfer (mass transport) from one electrode to the other. Furthermore, the seal should be sufficient to prevent leakage of the hydrogen gas that is generated and consumed by the cells within the battery. Seals 70 shown in FIG. 2 are shaped in the form of bellows so as to allow the longitudinal expansion and contraction of the cells during charging and discharging. Such bellows are made of a flexible material that is not particularly well suited for thermal conduction.

### SUMMARY OF THE INVENTION

According to a first aspect of the present invention, an electrochemical cell comprises: a plurality of cell components including at least a positive electrode, a negative electrode, a separator, and a current collector; and a plastic seal component secured about a periphery of at least one of the cell components.

According to another aspect of the present invention, an electrochemical battery comprises a plurality of electrochemical cells, Each electrochemical cell comprises: a plurality of cell components including at least a positive electrode, a negative electrode, a separator, and a current collector, and a plastic seal component secured about a periphery of at least one of the cell components, wherein the plastic seal components are bonded to one another.

According to another aspect of the present invention, a method of making a bipolar electrochemical cell comprises: providing at least one bipolar cell component of the electrochemical cell, the cell component being relatively flat and having a peripheral edge; and securing a plastic seal component around the peripheral edge of the cell component.

According to another aspect of the present invention, a method of constructing a bipolar electrochemical cell structure comprises: placing in a mold cavity at least one bipolar cell component selected from the group consisting of: a positive electrode, a negative electrode, a separator, and a current collector; and injection molding a plastic seal component into the mold cavity to secure the plastic seal component to the cell component.

According to another aspect of the present invention, a method of making a battery comprises: providing at least two electrochemical cells each having a plastic seal component extending along at least a portion of a peripheral edge of the electrochemical cell; and bonding the plastic seal components of the electrochemical cells.

According to another aspect of the present invention, a seal for an electrochemical cell comprising a seal component made of a plastic and filled with a material having a thermal conductivity greater than that of the plastic.

According to another aspect of the present invention, a segmented nickel hydrogen battery system comprises: a container; a hydrogen storage segment provided in the container; and a nickel hydrogen battery segment provided in the container in fluid communication with the hydrogen storage segment, wherein the battery segment generates thermal energy during discharge, and wherein such thermal energy is contained in the container so as to heat the hydrogen storage segment during discharge.

According to another aspect of the present invention, a method of operating a segmented nickel hydrogen battery system comprises the steps of: providing a nickel hydrogen battery segment that generates thermal energy during discharge; providing a hydrogen storage segment in fluid communication with the nickel hydrogen battery segment; and positioning the hydrogen storage segment proximate the nickel hydrogen battery segment such that the thermal energy generated during discharge heats the hydrogen storage segment.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a schematic cross-sectional view of a conventional segmented nickel hydrogen battery system;

FIG. 2 is a cross-sectional view of a conventional battery segment of the nickel hydrogen battery system shown in FIG. 1;

FIG. 3 is a top plan view of an electrochemical cell component used in the battery system of the present invention;

FIG. 4 is a cross-sectional view of the component shown in FIG. 3 taken along line IV-IV;

FIG. 5 is a cross-sectional view of a plurality of the components shown in FIGS. 3 and 4 in a stacked arrangement;

FIG. 6 is a schematic view of a segmented nickel hydrogen battery system constructed in accordance with the present invention;

FIG. 7 is a perspective view of a battery component according to a second embodiment of the present invention;

FIG. 8 is a perspective view of a battery component according to a third embodiment of the present invention;

FIG. 9 is a top plan view of a battery component according to a fourth embodiment of the present invention;

FIG. 10 is a cross-sectional view of a portion of the component shown in FIG. 9 taken along line X-X; and

FIG. 11 is a cross-sectional view of a portion of the component shown in FIG. 9 taken along line XI-XI.

### DETAILED DESCRIPTION OF THE PREFERRED EMBODIMENTS

According to one aspect of the present invention, the invention generally relates to an improvement in the manner by which the hydrogen storage segment of a nickel hydrogen battery system may be heated. Specifically, an improved and novel seal design is disclosed that allows the transfer of heat that is generated from within the battery segment to the hydrogen storage segment during discharge. The improved seal design further allows for a construction that is more simple to manufacture and thus less costly.

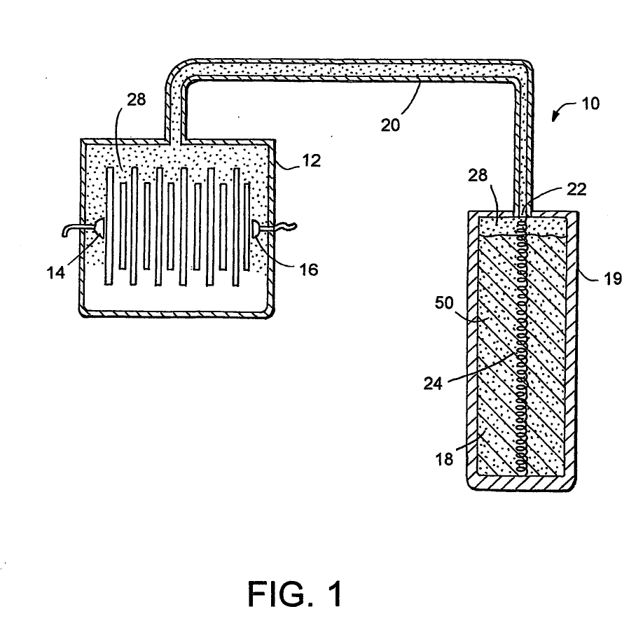

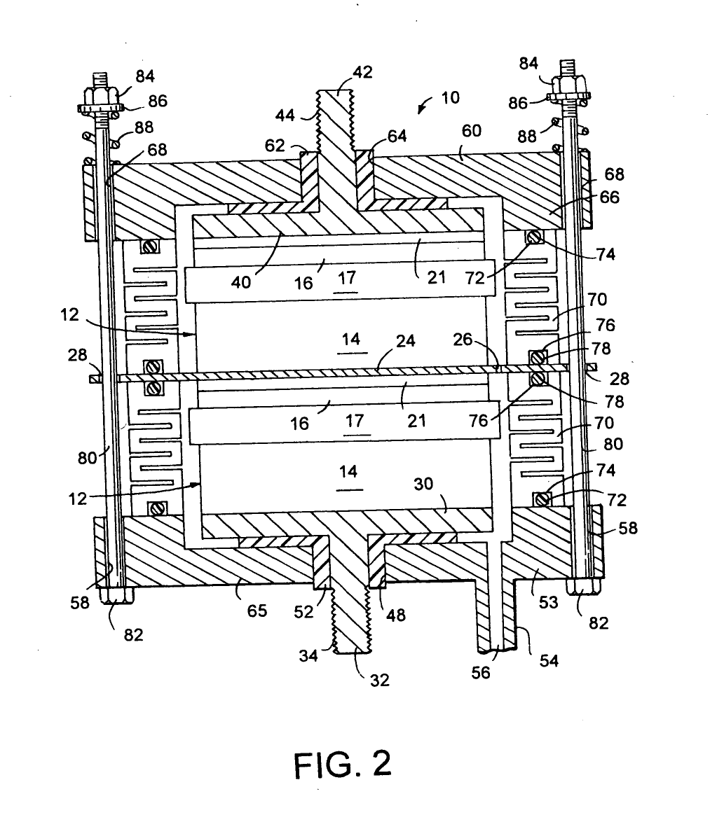

The nickel hydrogen battery system of the present invention generally includes the features shown in FIG. 1 and has a stacked cell structure having many cell components similar to the conventional structure shown in FIG. 2 and described above. The present invention differs, however, in the manner in which the electrochemical cells of the battery segment are stacked and sealed between end plates 60 and 65. As will be described in detail below, a plastic seal component is secured to the peripheral edges of at least one of the other components of each cell. The plastic seal component of each cell may be configured to allow for registration of the cells relative to one another and to allow subsequent bonding or adhering of the seal components to one another to provide an airtight and watertight integral seal so as to prevent leakage of hydrogen gas and electrolyte even at high pressure.

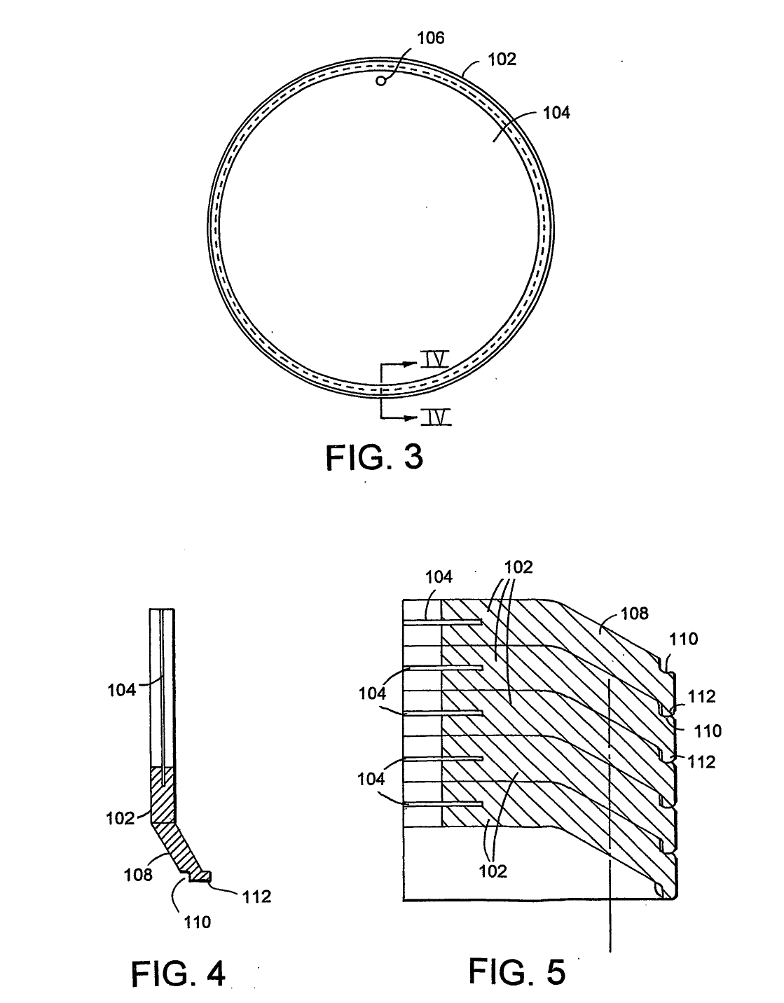

FIG. 3 shows a plan view of the top of an electrochemical cell constructed in accordance with a first embodiment of the present invention. As shown, the cell includes a plastic seal component 102 in the shape of a ring, which extends about at least a portion of the peripheral edge of at least one other component of the electrochemical cell. In the embodiment disclosed, this other cell component is a disk-shaped current collector plate 104, which is typically formed of nickel. As shown in FIG. 3, a hole 106 may be formed through each current collector plate 104, which may be used for orienting and registering the stacked plates relative to one another.

FIG. 4 shows a cross-sectional view of this construction taken along line IV-IV in FIG. 3. As shown in FIG. 4, the plastic seal component 102 is generally flat with a slot in which the peripheral edge of collector plate 104 is secured. The plastic seal component 102 may have an angled skirt 108 in which a radiused shoulder 110 is formed at its distal end. A corresponding protruding leg 112 extends in the opposite direction at the distal end and outermost periphery of seal segment 102. As shown in FIG. 5, the legs 112 of each adjacent seal component ring 102 are configured to fit within the radiused shoulder 110 on an adjacent seal component ring 102. In this manner, a plurality of the seal components 102 may be stacked upon one another in an interlocking manner.

As shown in FIG. 5, seal components 102 support the current collector plates 104 such that they are parallel and spaced apart. When these cell components are stacked in the manner shown in FIG. 5, the other components of the electrochemical cell may be placed between each adjacent pair of collector plates 104.

Plastic ring seal components 102 may be joined to current collector plates 104 using a variety of techniques. For example, plastic rings 102 may be injection-molded around collector plates 104. Other techniques include molding the plastic ring with a lip around its circumference, where the lip may be compressed around the nickel creating a seal when assembled. Such a lip may be made of Teflon® and may be molded over the collector plate. Alternatively, the plastic seal component may be formed having heat stakes extending axially in parallel to its central longitudinal axis and apertures may be formed in the collector plates that correspond to each of the heat stakes and then the heat stakes may be deformed by ultrasonic or heat welding. Alternatively, adhesive bonds or chemical bonds may be used. As yet another alternative, a compression seal may be used such that the parts are squeezed together to remain in contact. The preferred method, however, is to form the seal components 102 by injection molding them around the circumference of the collector plates 104.

Plastic seal components 102 are preferably formed of a material that has a coefficient of thermal expansion that matches that of the material from which collector plates 104 are formed. When utilizing a nickel current collector plate 104, suitable plastics that may be used include polyphenol sulfide (PPS), ABS, polypropylene (PP), PSU, PEEK, PTFE (Teflon®), and high density polyethylene (HDPE), with the presently preferred material being PP.

In a preferred embodiment, the plastic seal component 102 is formed with a filler material in the plastic so as to render the ring portions more thermally conductive. Suitable thermal conductive fillers that may be used with the plastics noted above have a higher thermal conductivity than the plastic used and may include boron nitride, aluminum nitride, alumina, and silica. By forming the seal of a thermally conductive plastic, the seal can aid in the removal of heat generated in the chemical reaction of the battery segment. The specific manner in which such heat transfer can occur is described further below.

The use of such a thermally conductive seal allows for better high-power and high-rate discharge of the battery system. Specifically, temperature plays an important role in the fundamental battery chemical reaction and can result in significantly reducing the battery performance, life cycle, and cost. Conversely, optimizing the control of the temperature within the chemical reaction will result in achieving unsurpassed performance within the chemical system. It is, therefore, important to understand the effects of the ambient temperature on battery performance, the means and sources of heat generation within the battery system, and the effects of operating temperature on the battery performance as it relates to charge acceptance, discharge efficiency, battery weight, and battery cost.

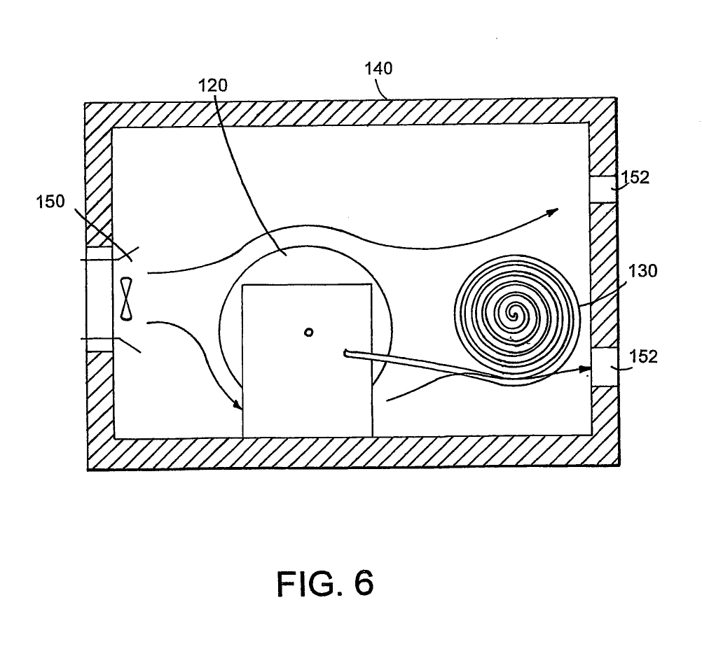

As noted above and described further with respect to FIG. 6, as hydrogen gas flows from the hydrogen storage segment 130 to the electrochemical segment 120, the hydrogen storage segment cools and the electrochemical segment increases in temperature. The cooling of the hydrogen storage segment 130 slows the release of hydrogen from the metal hydride in which it is stored. Without the addition of heat to the hydrogen storage segment 130, the battery system would eventually stop functioning. As the power demand on the battery system is increased, more hydrogen gas is needed by the electrochemical segment 120 at a faster rate. The availability and rate of availability of this gas is dependent on proper heat flow back to the hydrogen storage segment 130. Through the use of the thermally conductive plastic seal of the present invention and air movement between the storage segment 130 and electrochemical segment 120, heat generated in the electrochemical segment 120 may be transferred back to the hydrogen storage segment 130 in order to provide the heat required for high power performance.

To further demonstrate the manner by which this heat transfer may occur, reference is made to FIG. 6. As shown, both the hydrogen storage segment 130 and the electrochemical segment 120 are contained in a common enclosure 140. In prior art designs, the two segments were typically not contained in a common enclosure. Such an enclosure 140 serves to allow for heat generated by the electrochemical segment 120 to reach the storage segment 130 and for both to be somewhat more insulated from ambient temperatures in the surrounding environment. A fan 150 is preferably mounted on the side wall of the enclosure so as to blow air from outside the enclosure 140 across the outer surface of the electrochemical segment 120, including its thermally conductive plastic seal, towards the hydrogen storage segment 130. Venting holes 152 may thus be provided on the other side of enclosure 140 for adequate airflow. Hydrogen storage segment 130 preferably includes a long coiled tube of thermally conductive material in which metal hydride is contained. Preferably, the fan provides for 0.7 CFN of airflow. With the disclosed design, the plastic seal will pass at least about 1.2 W/mK of thermal energy from the electrochemical segment 120, which may then be transferred to the hydrogen storage segment 130 in the manner described above.

Referring back to FIG. 5, after the plastic seal components 102 are formed about the circumference of the collector plates 104, these structures are stacked on top of each other with a seal component corresponding to each individual cell of the battery segment. A cross-sectional view of this construction is shown in FIG. 5. After the components are stacked, heat may then be applied to melt the seal components 102 together into a continuously and integrally sealed unit. Such heat should be above the surface melt temperature of the plastic material forming the seal components 102 so as to form a physical bond between each seal component. The thickness of the bond is at least 0.030 inch thick with the use of polypropylene as the plastic seal material in order to properly seal the battery stack. The resulting integral seal is sufficient to prevent electrolyte from leaking from the battery cells. Heat is preferably applied to the seal components using a flame as the heat source. Other sources may include a hot can, furnace, or other forms of radiant heat including infrared or ultraviolet light.

It should be noted, however, that the seal components 102 may be bonded or joined using other methods including adhesive, glue, solvents, or chemical melting of the seals.

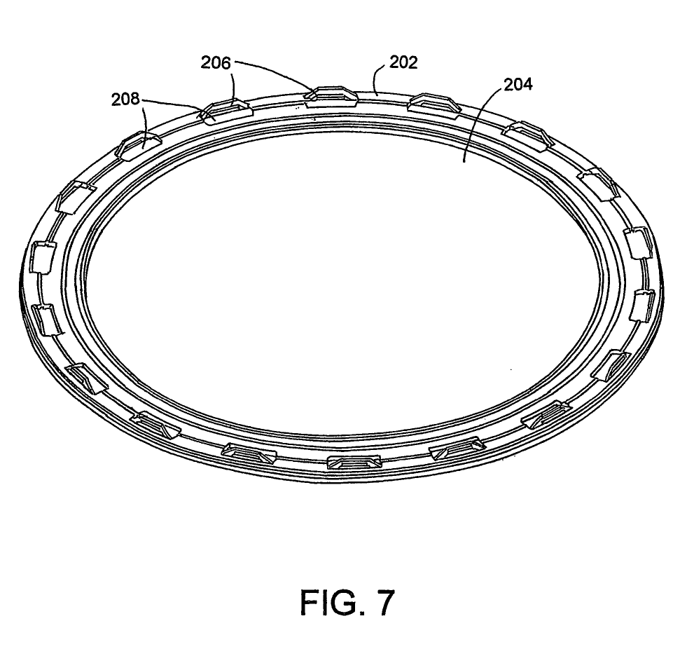

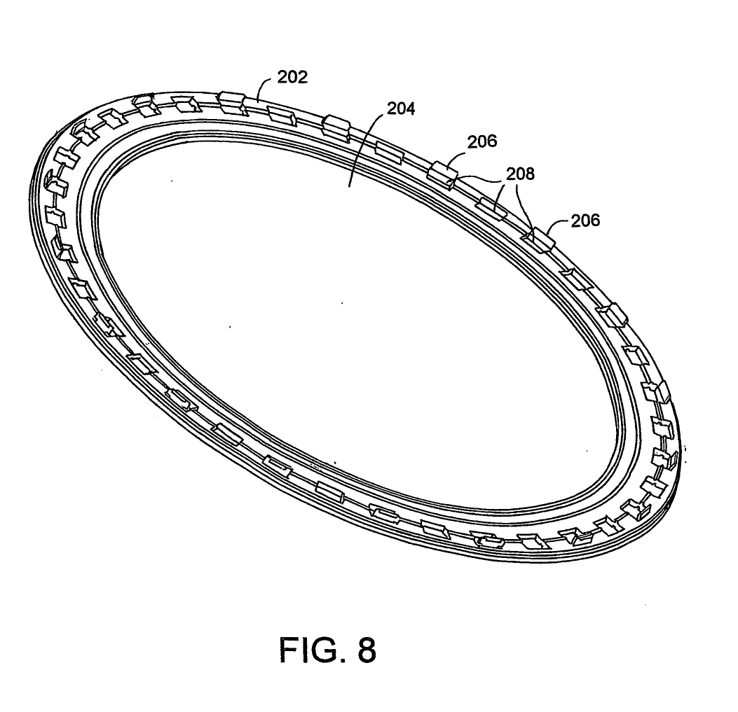

FIGS. 7 and 8 are perspective views of two different embodiments of the above-described structure. Specifically, both of these embodiments include a plastic ring seal portion 202 including a plurality of tabs 206 and slots 208 that allow for interlocking of adjacent seal components by mechanical means. Such a structure may be sufficient to hold the seals together; however, it may still be preferable to apply heat to physically bond the adjacent seal portions 202 together.

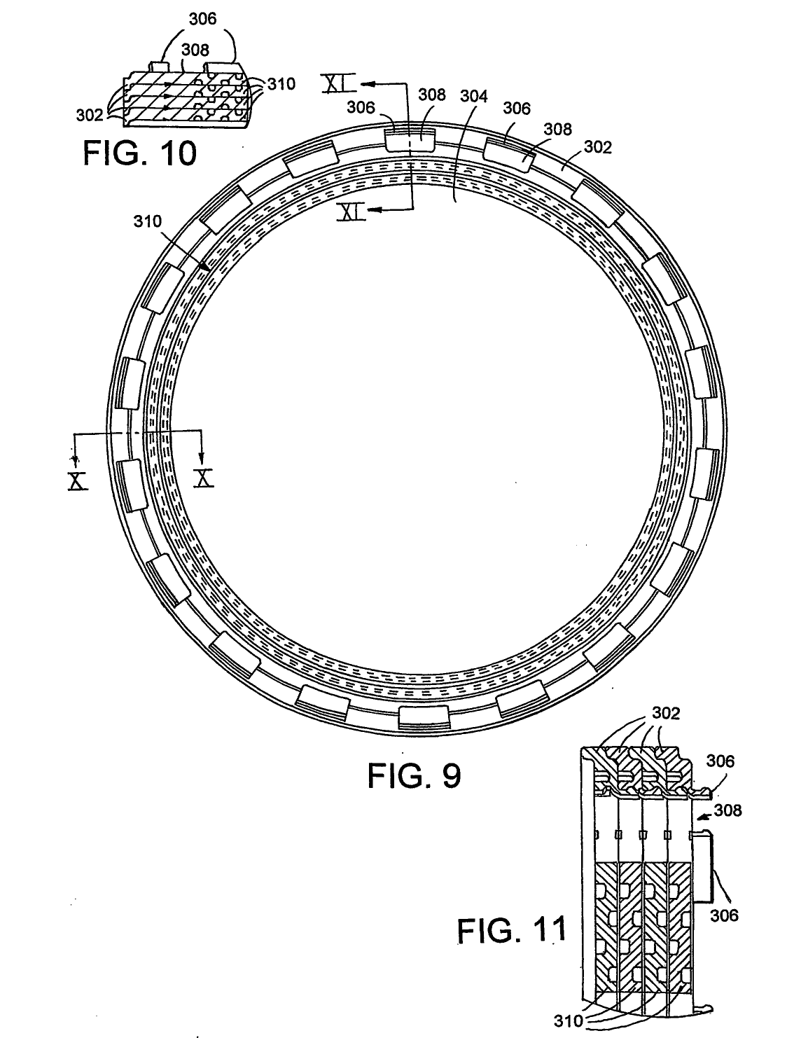

FIGS. 9-11 illustrate yet another embodiment of the present invention. In this embodiment, the plastic ring seal portions 302 are configured to include one or more spring-like mechanisms 310 so as to allow for thermal expansion and contraction of the electrochemical cells within the structure.

Although the invention has been described above wherein the plastic seal components are secured to the collector plates, the seal components could be secured to other cell components such as the negative electrode, the positive electrode, the separator, the gas diffusion membrane, or combinations of any of these cell components. For example, the seal component may be secured to a complete or partially complete bipolar cell stack.

It should also be noted that the invention is not limited to any specific materials for the electrodes, separator, collector plate, and gas diffusion membrane. Any conventional materials may be used.

Although the present invention has been described above with respect to use in segmented nickel hydrogen battery systems, certain aspects of the present invention may be employed in other electrochemical cells or batteries having other chemistries. For example, the use of a plastic seal for each cell to allow subsequent bonding and stacking of the cells may be used in lithium ion batteries, lead acid batteries, and nickel metal hydride batteries. Furthermore, the use of a thermally conductive seal such as that described above may be employed in lithium ion batteries and any high-power battery system including high-power lead acid systems.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. An electrochemical cell comprising:
a plurality of cell components including at least a positive electrode, a negative electrode, a separator, and a current collector; and
a plastic seal component secured about a periphery of at least one of said cell components,
wherein said plastic seal component includes a plastic material and a filler material having a higher thermal conductivity than the plastic material.

2. (canceled)

3. The electrochemical cell of claim 1, wherein said cell components are components of a bipolar electrochemical cell.

4. The electrochemical cell of claim 1, wherein said cell components are components of a nickel hydrogen electrochemical cell.

5. The electrochemical cell of claim 1, wherein said plastic seal component is bonded to the current collector.

6. The electrochemical cell of claim 1, wherein the at least one cell component to which said plastic seal component is secured, is shaped like a disk, and said plastic seal component is shaped like a ring and extends about the circumference of said at least one cell component.

7. An electrochemical battery comprising:
a plurality of electrochemical cells, each electrochemical cell comprising:
a plurality of cell components including at least a positive electrode, a negative electrode, a separator, and a current collector, and
a plastic seal component secured about a periphery of at least one of said cell components,
wherein said plastic seal components are bonded to one another, and
wherein said cell components are components of a nickel hydrogen electrochemical cell.

8. The electrochemical battery of claim 7, wherein said plastic seal components are thermally bonded to one another.

9. The electrochemical battery of claim 7, wherein said plastic seal components are chemically bonded to one another.

10. The electrochemical battery of claim 7, wherein said plastic seal components are adhesively bonded to one another.

11. The electrochemical battery of claim 7, wherein said plastic seal components are bonded to the current collectors of the electrochemical cells.

12. The electrochemical battery of claim 7, wherein the at least one cell component to which said plastic seal component is secured, is shaped like a disk, and said plastic seal component is shaped like a ring and extends about the circumference of said at least one cell component.

13. The electrochemical battery of claim 7, wherein said plastic seal component includes a plastic material and a filler material having a higher thermal conductivity than the plastic material.

14. The electrochemical battery of claim 7, wherein said cell components are components of a bipolar electrochemical cell.

15. (canceled)

16. A method of making a bipolar electrochemical cell comprising:
providing at least one bipolar cell component of the electrochemical cell, the cell component being relatively flat and having a peripheral edge; and
securing a plastic seal component around the peripheral edge of said cell component.

17. The method of claim 16, wherein said step of securing the plastic seal includes injection molding the plastic seal around the peripheral edge of the cell component.

18. The method of claim 16, wherein the cell component is shaped as a disk and the seal component is shaped as a ring about the periphery of the disk-shaped cell component.

19. A method of constructing a bipolar electrochemical cell structure comprising:
placing in a mold cavity at least one bipolar cell component selected from the group consisting of: a positive electrode, a negative electrode, a separator, and a current collector; and
injection molding a plastic seal component into the mold cavity to secure the plastic seal component to the cell component.

20. A method of making a battery comprising:
providing at least two electrochemical cells each having a plastic seal component extending along at least a portion of a peripheral edge of the electrochemical cell; and
bonding the plastic seal components of the electrochemical cells.

21. A seal for an electrochemical cell comprising a seal component made of a plastic material and a filler material having a thermal conductivity greater than that of the plastic material.

22. An electrochemical cell comprising the seal of claim 21.

23. A nickel hydrogen electrochemical cell comprising the seal of claim 21.

24. A segmented nickel hydrogen battery system comprising:
a container;
a hydrogen storage segment provided in said container; and
a nickel hydrogen battery segment provided in said container in fluid communication with said hydrogen storage segment,
wherein said battery segment generates thermal energy during discharge, and wherein such thermal energy is contained in said container so as to heat said hydrogen storage segment during discharge.

25. The segmented nickel hydrogen battery system of claim 24 and further comprising a fan for circulating air over the outside of said battery segment and towards said hydrogen storage segment.

26. The segmented nickel hydrogen battery system of claim 24, wherein said battery segment includes a plastic seal made of a plastic material and a filler material having a greater thermal conductivity than the plastic material.

27. The segmented nickel hydrogen battery system of claim 26, wherein said plastic seal is provided as an outside surface of said battery segment.

28. A method of operating a segmented nickel hydrogen battery system, the method comprising the steps of:
providing a nickel hydrogen battery segment that generates thermal energy during discharge;
providing a hydrogen storage segment in fluid communication with the nickel hydrogen battery segment; and
positioning the hydrogen storage segment proximate the nickel hydrogen battery segment such that the thermal energy generated during discharge heats the hydrogen storage segment.

29. The method of claim 28 further including the step of placing the hydrogen storage segment and the nickel hydrogen battery segment in a common container.
